(19) United States
(12) Patent Application Publication
(10) Pub. No.: US 2026/0300334 A1
(43) Pub. Date: Oct. 1, 2026

(54) INFORMATION PROCESSING APPARATUS, INFORMATION PROCESSING METHOD, AND INFORMATION PROCESSING SYSTEM

(71) Applicant: Shota WATANABE, KANAGAWA (JP)

(72) Inventor: Shota WATANABE, KANAGAWA (JP)

(73) Assignee: Ricoh Company, Ltd., Tokyo (JP)

(21) Appl. No.: 19/542,073

(22) Filed: Feb. 17, 2026

(30) Foreign Application Priority Data
Mar. 31, 2025 (JP) 2025-057683

(51) Int. Cl. G06F 16/3329; G06F 16/338

(52) U.S. Cl. CPC G06F 16/3329; G06F 16/338

(57) ABSTRACT

An information processing apparatus includes circuitry that receives an input of input data, outputs a first prompt to a large language model, and transmits output data to a terminal apparatus. The first prompt requests to infer, using reference data, a relation between an issue of an industry indicated by the input data and an issue of a different industry. The reference data is stored in a memory for each organization of a plurality of organizations in different industries, and associates organization data related to the organization with processed data including a generically conceptualized issue generalized from an issue of the organization. The different industry shares the generically conceptualized issue with the industry indicated by the input data. The output data includes an inference result from the large language model, and indicates the relation between the issue of the industry indicated by the input data and the issue of the different industry.

### CROSS-REFERENCE TO RELATED APPLICATIONS

This patent application is based on and claims priority pursuant to 35 U.S.C. § 119(a) to Japanese Patent Application No. 2025-057683, filed on Mar. 31, 2025, in the Japan Patent Office, the entire disclosure of which is hereby incorporated by reference herein.

### BACKGROUND

### Technical Field

The present disclosure relates to an information processing apparatus, an information processing method, and an information processing system.

### Related Art

There is a technique of extracting, from organization information of an organization similar to a company whose issue is to be inferred (an issue inference target), an issue specific to the organization to refer to an issue of a group of organizations (industry) similar in company background to the company and infer an issue applicable to but unrecognized by the company as the issue inference target.

### SUMMARY

The present disclosure described herein provides an information processing apparatus that includes, for example, circuitry that receives an input of input data, outputs a first prompt to a large language model, and transmits output data to a terminal apparatus. The first prompt requests to infer, using reference data, a relation between an issue of an industry indicated by the input data and an issue of a different industry. The reference data is stored in a memory for each organization of a plurality of organizations in different industries. The reference data associates organization data related to the organization with processed data including a generically conceptualized issue generalized from an issue of the organization. The different industry shares the generically conceptualized issue with the industry indicated by the input data. The output data includes an inference result from the large language model, and indicates the relation between the issue of the industry indicated by the input data and the issue of the different industry sharing the generically conceptualized issue with the industry indicated by the input data.

The present disclosure described herein further provides an information processing apparatus that includes, for example, circuitry that receives an input of input data, transmits a search request to an external server to search for a work corresponding to the input data, and acquires a search result including data indicating the work corresponding to the input data. The circuitry further transmits another search request to the external server to, with a list of industries inferred based on the work as a search key, search for an issue of a different industry different from the industries and sharing a generically conceptualized issue generalized from an issue of the industries. The circuitry acquires data indicating the issue of the different industry as another search result, and outputs a first prompt to a large language model. The first prompt includes owned technique information related to a technique owned by a particular organization, the data indicating the work corresponding to the input data, and the data indicating the issue of the different industry. The first prompt requests to infer an issue related to the owned technique information and applicable to an industry indicated by the input data, and infer a measure using the owned technique information to address the issue related to the owned technique information and applicable to the industry indicated by the input data. The circuitry transmits, to a terminal apparatus, output data including an inference result from the large language model.

The present disclosure described herein further provides an information processing method that includes, for example, receiving an input of input data, outputting a first prompt to a large language model, and transmitting output data to a terminal apparatus. The first prompt requests to infer, using reference data, a relation between an issue of an industry indicated by the input data and an issue of a different industry. The reference data is stored in a memory for each organization of a plurality of organizations in different industries. The reference data associates organization data related to the organization with processed data including a generically conceptualized issue generalized from an issue of the organization. The different industry shares the generically conceptualized issue with the industry indicated by the input data. The output data includes an inference result from the large language model, and indicates the relation between the issue of the industry indicated by the input data and the issue of the different industry sharing the generically conceptualized issue with the industry indicated by the input data.

The present disclosure described herein further provides an information processing system that includes, for example, an information processing apparatus and a terminal apparatus that communicates with the information processing apparatus via a network. The information processing apparatus includes first circuitry that receives an input of input data, outputs a first prompt to a large language model, and transmits output data to a terminal apparatus. The first prompt requests to infer, using reference data, a relation between an issue of an industry indicated by the input data and an issue of a different industry. The reference data is stored in a memory for each organization of a plurality of organizations in different industries. The reference data associates organization data related to the organization with processed data including a generically conceptualized issue generalized from an issue of the organization. The different industry shares the generically conceptualized issue with the industry indicated by the input data. The output data includes an inference result from the large language model, and the indicates the relation between the issue of the industry indicated by the input data and the issue of the different industry sharing the generically conceptualized issue with the industry indicated by the input data. The terminal apparatus includes second circuitry that receives the output data, and displays the received output data on a display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of an information processing system according to a first embodiment of the present disclosure;

FIG. 2 is a diagram illustrating an example of a hardware configuration of an information processing apparatus included in the information processing system of the first embodiment;

FIG. 3 is a diagram illustrating an example of a hardware configuration of a terminal apparatus included in the information processing system of the first embodiment;

FIG. 4 is a diagram illustrating functional configurations of apparatuses included in the information processing system of the first embodiment;

FIG. 5 is a sequence diagram illustrating an operation of the information processing system of the first embodiment;

FIG. 6 is a diagram illustrating an example of reference data of the first embodiment;

FIG. 7 is a sequence diagram illustrating another operation of the information processing system of the first embodiment;

FIG. 8 is a diagram illustrating an example of response data of the first embodiment;

FIG. 9 is a diagram illustrating a display example of the terminal apparatus of the first embodiment;

FIG. 10 is a diagram illustrating functional configurations of apparatuses included in an information processing system according to a second embodiment of the present disclosure;

FIG. 11 is a sequence diagram illustrating an operation of the information processing system of the second embodiment;

FIGS. 12A, 12B, and 12C are diagrams illustrating results of processing by units of an information processing apparatus of the second embodiment;

FIG. 13 is a diagram illustrating functional configurations of apparatuses included in an information processing system according to a third embodiment of the present disclosure;

FIG. 14 is a diagram illustrating an example of owned technique information stored in an owned technique storage unit of an information processing apparatus of the third embodiment;

FIG. 15 is a sequence diagram illustrating an operation of the information processing system of the third embodiment;

FIG. 16 is a diagram illustrating an example of a search result of the third embodiment;

FIG. 17 is a diagram illustrating a display example of the terminal apparatus of the third embodiment;

FIG. 18 is a sequence diagram illustrating an operation of an information processing system according to a fourth embodiment of the present disclosure;

FIG. 19 is a diagram illustrating a display example of the terminal apparatus of the fourth embodiment;

FIG. 20 is a diagram illustrating functional configurations of apparatuses included in an information processing system according to a fifth embodiment of the present disclosure;

FIG. 21 is a sequence diagram illustrating an operation of the information processing system of the fifth embodiment; and

FIG. 22 is a diagram illustrating a display example of the terminal apparatus of the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A first embodiment of the present disclosure will be described with drawings.

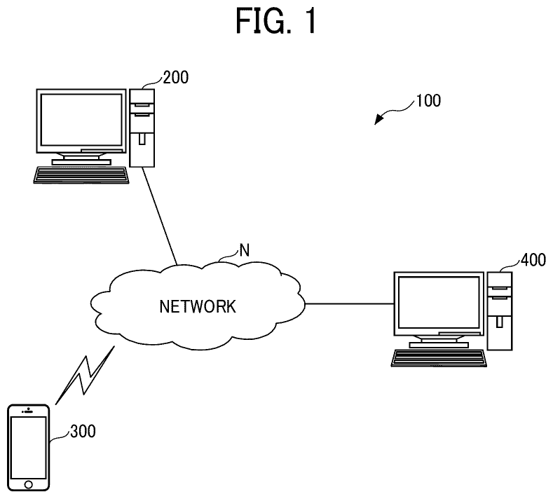

FIG. 1 is a diagram illustrating an example of the system configuration of an information processing system 100 according to the first embodiment.

The information processing system 100 includes an information processing apparatus 200 and a terminal apparatus 300. In the information processing system 100, the information processing apparatus 200 and the terminal apparatus 300 are communicably connected to each other via a network N. The information processing apparatus 200 communicates with a server apparatus 400 via the network N.

In the first embodiment, the network N may be a wide-area network such as the Internet or a wide area network (WAN), a local area network (LAN), a network using a technology such as wireless fidelity (Wi-Fi®) or wide-area Ethernet®, or a mobile phone network using a technology such as fourth generation (4G), fifth generation (5G), or sixth generation (6G), for example.

The server apparatus 400 includes a large language model (LLM) that implements generative artificial intelligence (AI). The generative AI generates text data in accordance with an input prompt, as in chat generative pre-trained transformer (ChatGPT), for example, and outputs the text data to the information processing apparatus 200. In the first embodiment, the prompt refers to text data for expressing an instruction or question to the generative AI implemented by the server apparatus 400. Details of the LLM will be described later.

It suffices if the information processing system 100 includes the information processing apparatus 200 and the terminal apparatus 300; the information processing system 100 may or may not include the server apparatus 400.

The terminal apparatus 300 is used mainly by a user of the information processing system 100. The user of the information processing system 100 is, for example, a person belonging to an organization to which a service provided by the information processing system 100 is introduced. In the first embodiment, the organization is a group for achieving a particular goal, such as a company, for example. The organization of the first embodiment may be other than the company, such as an educational or medical institution, for example.

The information processing apparatus 200 includes a reference data storage unit that stores reference data. The reference data associates organization data with processed data. The organization data is related to each organization of a plurality of organizations in different industries. The processed data is processed from the organization data into a particular format. Details of the reference data storage unit will be described later. In the first embodiment, an industry refers to the type or field of business conducted by the organization, such as transport, finance, or real estate, for example.

In the first embodiment, the organization data refers to data including the industry of the organization, an issue of the organization, a work undertaken to address the issue, the progress of the work, and the achievement of the work. The organization data of the first embodiment is a monthly report, for example. The organization data may also include various reports, minutes of meetings, and various data handled in the organization, for example. The organization data of the first embodiment is created in each organization.

In the first embodiment, the processed data refers to data converted from the organization data into a format suitable for being searched. The processed data is, for example, various data extracted from the organization data and formatted into a list. The processed data includes an issue generically conceptualized (generalized) from an issue specific to the organization corresponding to the organization data. The processed data further includes a list of industries that are likely to share the generically conceptualized issue. Details of the organization data and the processed data will be described later.

In response to input of input data via the terminal apparatus 300, the information processing apparatus 200 searches the reference data storage unit with the input data as a search key, and acquires the processed data as a search result. The input data includes at least one of an industry, a work, or an organization name as an issue inference target whose issue is to be inferred.

The information processing apparatus 200 then generates a prompt requesting to identify, in the processed data acquired as the search result, processed data including an issue highly related to the issue of the industry indicated by the input data. The information processing apparatus 200 outputs the generated prompt to the server apparatus 400.

Then, the information processing apparatus 200 acquires response data to the prompt from the server apparatus 400, obtains, from the reference data stored in the reference data storage unit, organization data corresponding to the processed data indicated by the response data, and outputs the organization data to the terminal apparatus 300.

In the first embodiment, the organization data of an organization that is in a different industry from the industry as the issue inference target and is inferred to be highly related to the issue of the industry as the issue inference target is thus output to the terminal apparatus 300.

The first embodiment therefore presents a user of the terminal apparatus 300 with the relation between the issue of the organization or industry as the issue inference target and the issue of the organization with a different background. In other words, the first embodiment presents an issue inference result including the information related to the organization in the different industry, without being restricted to the background of the organization as the issue inference target.

In the example of FIG. 1, the information processing apparatus 200 and the terminal apparatus 300 are configured as separate apparatuses. However, the information processing apparatus 200 and the terminal apparatus 300 are not limited to this configuration. The information processing apparatus 200 may also function as the terminal apparatus 300. Similarly, the information processing apparatus 200 and the server apparatus 400 are configured as separate apparatuses in the example of FIG. 1, but are not limited to this configuration. The server apparatus 400 may be included in the information processing apparatus 200.

In FIG. 1, the information processing apparatus 200 is implemented by one or more information processing apparatuses; the information processing apparatus 200 may be implemented by a plurality of information processing apparatuses.

An example of hardware configurations of the apparatuses included in the information processing system 100 will be described.

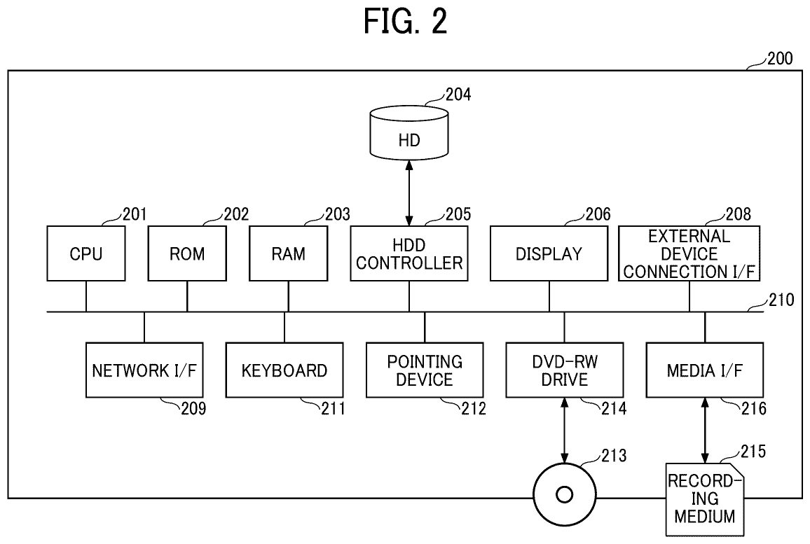

FIG. 2 is a diagram illustrating an example of the hardware configuration of the information processing apparatus 200 of the first embodiment. The information processing apparatus 200 illustrated in FIG. 2 is implemented by a computer (information processing apparatus). As illustrated in FIG. 2, the information processing apparatus 200 includes a central processing unit (CPU) 201, a read-only memory (ROM) 202, a random-access memory (RAM) 203, a hard disk (HD) 204, a hard disk drive (HDD) controller 205, a display 206, an external device connection interface (I/F) 208, a network I/F 209, a bus line 210, a keyboard 211, a pointing device 212, a digital versatile disc-rewritable (DVD-RW) drive 214, and a media I/F 216.

The CPU 201 controls overall operation of the information processing apparatus 200. The ROM 202 stores a program used to drive the CPU 201 such as an initial program loader (IPL). The RAM 203 is used as a work area for the CPU 201. The HD 204 stores various data such as programs. The HDD controller 205 controls the writing or reading of various data to or from the HD 204 under the control of the CPU 201. The display 206 displays various information such as a cursor, menus, windows, text, and images. The external device connection I/F 208 is an interface for connecting various external devices to the information processing apparatus 200. The external devices in this case include a universal serial bus (USB) memory and a printer, for example. The network I/F 209 is an interface for performing data communication via a communication network. The bus line 210 includes address buses and data buses for electrically connecting the CPU 201 and the other components in FIG. 2 to each other.

The keyboard 211 is an example of input means including a plurality of keys for inputting text, numerical values, and various instructions, for example. The pointing device 212 is an example of input means for selecting and executing various instructions, selecting a processing target, and moving the cursor, for example. The DVD-RW drive 214 controls the writing or reading of various data to or from a DVD-RW 213, which is an example of a removable recording medium. The removable recording medium is not limited to the DVD-RW, and may be a DVD-recordable (DVD-R), for example. The media I/F 216 controls the writing (storage) or reading of data to or from a recording medium 215 such as a flash memory.

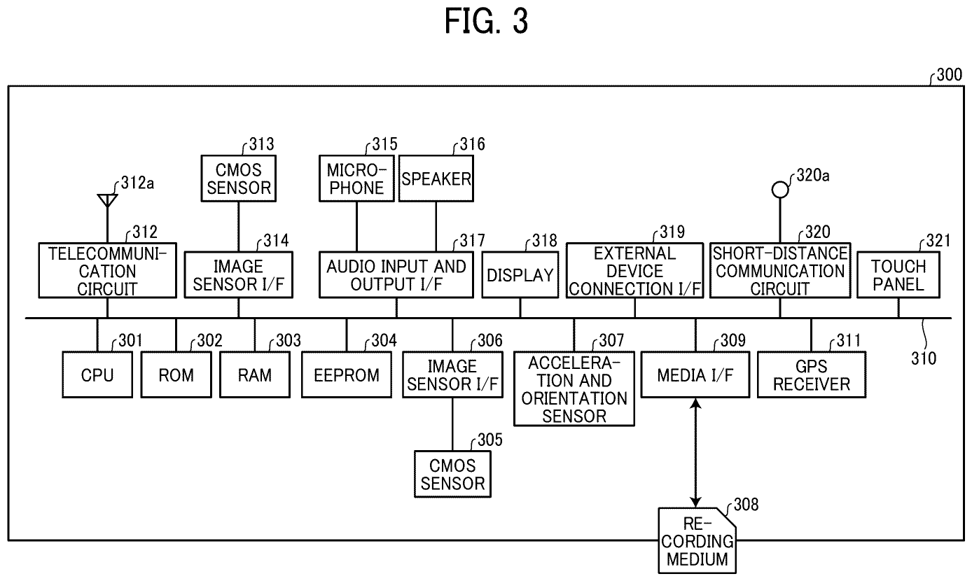

FIG. 3 is a diagram illustrating an example of the hardware configuration of the terminal apparatus 300 of the first embodiment. The terminal apparatus 300 includes a CPU 301, a ROM 302, a RAM 303, an electrically erasable programmable read-only memory (EEPROM) 304, a complementary metal-oxide semiconductor (CMOS) sensor 305, an image sensor I/F 306, an acceleration and orientation sensor 307, a media I/F 309, and a global positioning system (GPS) receiver 311.

The CPU 301 is an arithmetic processing device that controls overall operation of the terminal apparatus 300. The ROM 302 stores a program used to drive the CPU 301 such as an IPL. The RAM 303 is used as a work area for the CPU 301. The EEPROM 304 writes or reads various data such as smartphone programs under the control of the CPU 301. The ROM 302, the RAM 303, and the EEPROM 304 are examples of a storage device of the terminal apparatus 300.

The CMOS sensor 305 is an example of built-in imaging means for capturing the image of a subject (mainly the image of a user) under the control of the CPU 301 to obtain image data. The imaging means may be a charge-coupled device (CCD) sensor, for example, in place of the CMOS sensor.

The image sensor I/F 306 is a circuit that controls the driving of the CMOS sensor 305. The acceleration and orientation sensor 307 includes various sensors such as an electromagnetic compass that detects geomagnetism, a gyrocompass, and an acceleration sensor. The media I/F 309 controls the writing (storage) or reading of data to or from a recording medium 308 such as a flash memory. The GPS receiver 311 receives GPS signals from GPS satellites.

The terminal apparatus 300 further includes a telecommunication circuit 312, an antenna 312a for the telecommunication circuit 312, a CMOS sensor 313, an image sensor I/F 314, a microphone 315, a speaker 316, an audio input and output I/F 317, a display 318, an external device connection I/F 319, a short-distance communication circuit 320, an antenna 320a for the short-distance communication circuit 320, and a touch panel 321.

The telecommunication circuit 312 is a circuit that communicates with another apparatus via a communication network. The CMOS sensor 313 is an example of built-in imaging means for capturing the image of a subject under the control of the CPU 301 to obtain image data. The image sensor I/F 314 is a circuit that controls the driving of the CMOS sensor 313. The microphone 315 is a built-in circuit that converts sound into electrical signals. The speaker 316 is a built-in circuit that converts electrical signals into physical vibration to produce the sound of music or voice, for example. The audio input and output I/F 317 is a circuit that processes the input of audio signals from the microphone 315 and the output of audio signals to the speaker 316 under the control of the CPU 301.

The display 318 is an example of display means such as a liquid crystal or organic electroluminescence (EL) display for displaying the image of a subject, various icons, and so forth. The external device connection I/F 319 is an interface for connecting various external devices to the terminal apparatus 300. The short-distance communication circuit 320 is a communication circuit conforming to a standard such as near field communication (NFC) or Bluetooth^{®}. The touch panel 321 is an example of input means for the user to operate the terminal apparatus 300 by pressing the display 318. The display 318 is an example of a display unit included in the terminal apparatus 300.

The hardware configuration illustrated in FIG. 3 is an exemplary hardware configuration of the terminal apparatus 300. The hardware configuration of the terminal apparatus 300 is not limited thereto, and may be the hardware configuration illustrated in FIG. 2.

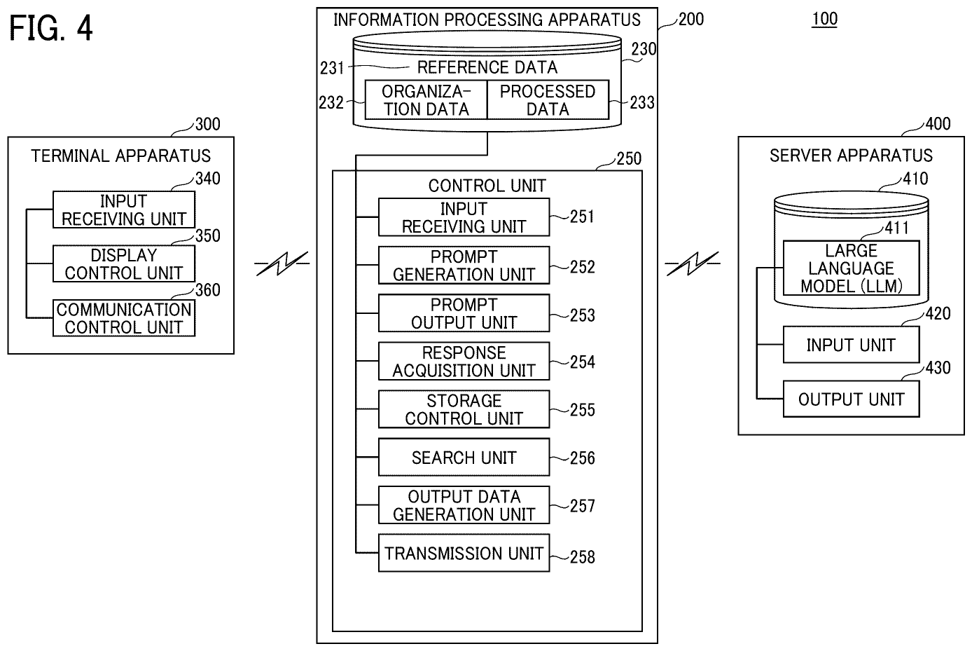

Functional configurations of the apparatuses included in the information processing system 100 will be described with reference to FIG. 4. FIG. 4 is a diagram illustrating functional configurations of the apparatuses included in the information processing system 100 of the first embodiment.

A functional configuration of the information processing apparatus 200 will be described first.

The information processing apparatus 200 includes a reference data storage unit 230 and a control unit 250.

The reference data storage unit 230 is implemented by the HD 204 of the information processing apparatus 200, for example. The reference data storage unit 230 stores reference data 231. The reference data 231 is data that associates organization data 232 with processed data 233. The reference data 231 in the reference data storage unit 230 is generated through a later-described process by the information processing apparatus 200 and stored in the reference data storage unit 230.

The control unit 250 is implemented by the CPU 201 of the information processing apparatus 200 reading and executing programs stored in the ROM 202 and the HD 204.

The control unit 250 includes an input receiving unit 251, a prompt generation unit 252, a prompt output unit 253, a response acquisition unit 254, a storage control unit 255, a search unit 256, an output data generation unit 257, and a transmission unit 258.

The input receiving unit 251 receives various inputs to the information processing apparatus 200. For example, the input receiving unit 251 receives, via the terminal apparatus 300, the input of a search key including an industry or work as the issue inference target. The input receiving unit 251 further receives the input of the organization data 232, which is stored in the reference data storage unit 230.

The prompt generation unit 252 generates a prompt to be output to the server apparatus 400. The prompt output unit 253 outputs the prompt generated by the prompt generation unit 252 to the server apparatus 400, and receives response data to the prompt from an LLM 411 included in the server apparatus 400.

The search unit 256 searches the reference data storage unit 230 based on the search key to acquire a search result. In the first embodiment, the input data from the terminal apparatus 300 is used as the search key. The search unit 256 therefore searches the reference data storage unit 230 based on the input data.

The output data generation unit 257 generates output data to be output to the terminal apparatus 300. The transmission unit 258 transmits the output data generated by the output data generation unit 257 to the terminal apparatus 300.

In the example of FIG. 4, the information processing apparatus 200 includes the reference data storage unit 230. However, the configuration is not limited thereto. The reference data storage unit 230 may be partially or entirely provided in an external device that is communicable with the information processing apparatus 200. Further, in the example of FIG. 4, the information processing apparatus 200 includes the control unit 250. However, the configuration is not limited thereto. The functions of the control unit 250 may be implemented by a plurality of information processing apparatuses. In other words, the functions of the information processing apparatus 200 may be implemented by a plurality of information processing apparatuses.

Functions of the terminal apparatus 300 will be described.

The terminal apparatus 300 includes an input receiving unit 340, a display control unit 350, and a communication control unit 360. The input receiving unit 340 receives an input to the terminal apparatus 300. The display control unit 350 controls the display of the display unit of the terminal apparatus 300. For example, the display control unit 350 causes the display unit to display data received from the information processing apparatus 200. The communication control unit 360 controls the communication of the terminal apparatus 300 with the information processing apparatus 200. For example, the communication control unit 360 transmits the input data received from the user to the information processing apparatus 200. The communication control unit 360 further receives from the information processing apparatus 200 the output data generated by the LLM 411, for example.

The input receiving unit 340, the display control unit 350, and the communication control unit 360 may be implemented by a world wide web (web) browser used by the terminal apparatus 300, or may be implemented by other means than the web browser. In the above-described example of the first embodiment, the data received from the information processing apparatus 200 is displayed on the display unit. However, the embodiment is not limited to the display of the data; the data received from the information processing apparatus 200 may be output or reproduced as audio.

The server apparatus 400 includes an LLM storage unit 410, an input unit 420, and an output unit 430. The LLM storage unit 410 stores the LLM 411, which implements generative AI.

The LLM 411 is a computer language model generated through a learning process with vast unlabeled text as learning data and formed with an artificial neural network with a multitude of parameters. The LLM 411 understands many of the sentence structures and word meanings of a human language through adequate training with methods for leaning context such as next sentence prediction and a masked language model, for example. The next sentence prediction determines whether two sentences are next to each other to understand context. The masked language model predicts a masked word in text based on preceding and following words to understand context.

The input unit 420 inputs a prompt output from the information processing apparatus 200 to the LLM 411. The output unit 430 outputs (transmits) the output data from the LLM 411 to the information processing apparatus 200. In other words, the output unit 430 transmits to the information processing apparatus 200 the response data output from the LLM 411 in response to the prompt.

An operation of the information processing system 100 will be described.

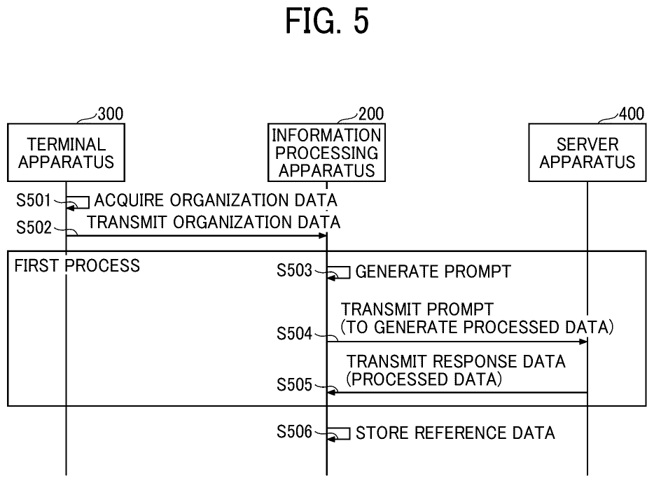

A process of generating the reference data 231 will be described first with reference to FIG. 5. FIG. 5 is a sequence diagram illustrating an operation of the information processing system 100 of the first embodiment.

In the information processing system 100, the terminal apparatus 300 acquires the organization data 232 (step S501), and transmits the organization data 232 to the information processing apparatus 200 (step S502). In the example of FIG. 5, the terminal apparatus 300 transmits the organization data 232 to the information processing apparatus 200. However, the transmission of the organization data 232 is not limited thereto. The organization data 232 may be transmitted to the information processing apparatus 200 by, for example, an administrator terminal used by an administrator different from the user of the terminal apparatus 300.

In the information processing apparatus 200, the input receiving unit 251 receives the input of the organization data 232, and the prompt generation unit 252 generates a prompt requesting to generate the processed data 233 based on the organization data 232 (step S503).

The prompt generated in this step includes text data requesting to generically conceptualize an issue specific to an organization included in the organization data 232 into a generic issue. The prompt generated in this step further includes text data requesting to output a list of industries that are likely to share the generically conceptualized issue.

In the information processing apparatus 200, the prompt output unit 253 then outputs the generated prompt to the server apparatus 400 (step S504), and the response acquisition unit 254 acquires from the server apparatus 400 response data output from the LLM 411 (step S505).

The storage control unit 255 of the information processing apparatus 200 then stores the reference data 231 in the reference data storage unit 230 (step S506). The reference data 231 associates the processed data 233, which is the response data acquired by the response acquisition unit 254, with the organization data 232 input at step S502.

The process in FIG. 5 to acquire the processed data 233 from the organization data 232 will be referred to as the first process. In FIG. 5, the first process corresponds to the processes of steps S503 to S505.

In the first embodiment, the reference data 231 is stored in the reference data storage unit 230 with the above-described process. In the first embodiment, the process of FIG. 5 is executed each time the organization data 232 is input to the information processing apparatus 200. However, the process of FIG. 5 is not limited thereto, and may be executed periodically. In this case, the information processing apparatus 200 accumulates the organization data 232 input to the reference data storage unit 230. Then, when executing the process of FIG. 5, the information processing apparatus 200 generates the reference data 231 including the accumulated organization data 232 and stores the generated reference data 231 in the reference data storage unit 230.

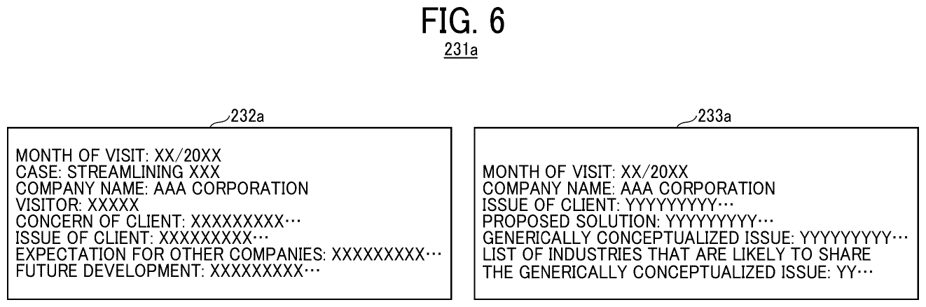

The reference data 231 stored in the reference data storage unit 230 of the information processing apparatus 200 will be described with reference to FIG. 6. FIG. 6 is a diagram illustrating an example of the reference data 231.

Reference data 231a is an example of the reference data 231 stored in the reference data storage unit 230. The reference data 231a is information that associates organization data 232a with processed data 233a. The reference data 231a is generated through a later-described process by the information processing apparatus 200.

In the example of FIG. 6, the organization data 232a includes data indicating case name, company name, concern, issue, expectation for other companies, future development, and so forth. In the example of FIG. 6, the processed data 233a includes company name, issue, proposed solution, generically conceptualized issue, and a list of industries that are likely to share the generically conceptualized issue.

In the first embodiment, the request is made to the LLM 411 to generate the processed data 233a with the organization data 232a. However, the generation of the processed data 233a is not limited thereto. For example, the processed data 233a may be manually created based on the organization data 232a and stored in the reference data storage unit 230.

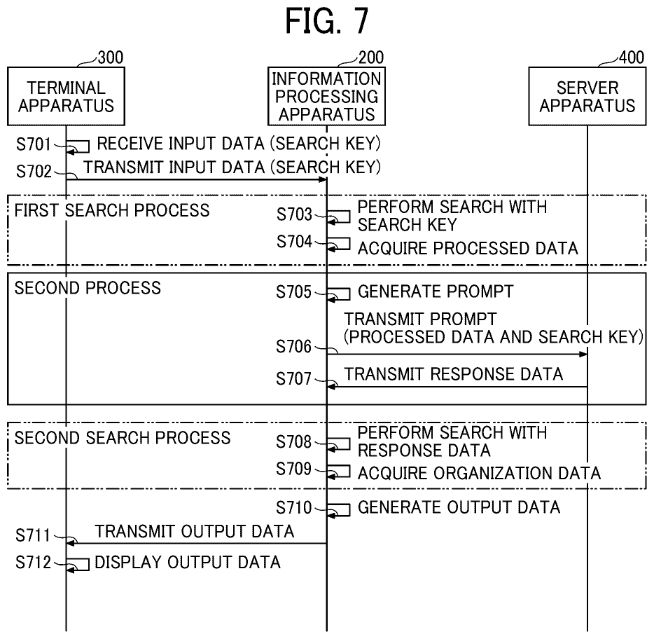

An operation to infer the issue in the first embodiment will be described with reference to FIG. 7. FIG. 7 is a sequence diagram illustrating another operation of the information processing system 100 of the first embodiment.

In the information processing apparatus 100, the input receiving unit 340 of the terminal apparatus 300 receives the input of a search kay (step S701), and the communication control unit 360 of the terminal apparatus 300 transmits the search key to the information processing apparatus 200 (step S702). The search key input in this step is, for example, one or more words indicating the industry as the issue inference target. However, the search key is not limited to the words indicating the industry as the issue inference target, and may be a work or an organization name, for example.

In the information processing apparatus 200, the input receiving unit 251 receives the input of the search key, and the search unit 256 searches through the processed data 233 of the reference data 231 stored in the reference data storage unit 230 with the search key (step S703) and acquires processed data 233 as a search result (step S704).

The prompt generation unit 252 of the information processing apparatus 200 then generates a prompt including the search key received at step S702 and the processed data 233 acquired at step S704 (step S705).

The prompt generated in this step includes the search key as the input data and the processed data 233 acquired as the search result. The prompt generated in this step further includes text data requesting to infer the relation between the industry or work indicated by the search key and the processed data 233 as the search result and text data requesting to identify the processed data 233 highly related to the search key.

In other words, the prompt generated in this step is a prompt requesting to infer the relation between the issue of the industry as the issue inference target indicated by the input data and the issue of a different industry that shares the generically conceptualized issue with the industry as the issue inference target. It is assumed here that the search key as the input data includes at least one of the industry, the work, or the organization name as the issue inference target.

The prompt output unit 253 of the information processing apparatus 200 outputs the prompt generated at step S705 to the server apparatus 400 (step S706). The response acquisition unit 254 of the information processing apparatus 200 then acquires from the server apparatus 400 response data output from the LLM 411 (step S707).

The response data acquired in this step is data identifying the processed data 233 highly related to the search key and data indicating the result of inferring the relation to the identified processed data 233. In other words, the response data acquired in this step includes data identifying the processed data 233 of the different industry sharing the generically conceptualized issue with the industry indicated by the input data, and also includes data indicating the result of inferring the relation between the issue of the industry indicated by the input data and the issue of the different industry. Details of the response data acquired at step S707 will be described later.

The search unit 256 of the information processing apparatus 200 then searches the reference data storage unit 230 with the processed data 233 included in the response data acquired by the response acquisition unit 254 (step S708). The search unit 256 further searches for the organization data 232 associated with the processed data 233 included in the response data, and acquires the organization data 232 as a search result (step S709).

Then, the output data generation unit 257 of the information processing apparatus 200 generates output data including the organization data 232 acquired at step S709 and the data included in the response data acquired at step S707 and indicating the result of inferring the relation between the search key and the processed data 233 (step S710).

The transmission unit 258 of the information processing apparatus 200 then transmits the output data generated at step S710 to the terminal apparatus 300 (step S711).

In the terminal apparatus 300, the communication control unit 360 receives the output data, and the display control unit 350 causes the display 318 to display the output data (step S712). Details of the output data displayed on the terminal apparatus 300 will be described later.

The process in FIG. 7 performed by the search unit 256 to search the processed data 233 in the reference data storage unit 230 with the search key will be referred to as the first search process. In FIG. 7, the processes of steps S703 and S704 correspond to the first search process.

The process in FIG. 7 to output the prompt and acquire the response data to the prompt will be referred to as the second process. The prompt includes the request to infer the relation between the industry or work indicated by the search key and the processed data 233 as the search result of the first search process, and also includes the request to identify the processed data 233 highly related to the search key. In FIG. 7, the processes of steps S705 to S707 correspond to the second process.

The process in FIG. 7 performed by the search unit 256 to search the organization data 232 in the reference data storage unit 230 with the processed data 233 of the different industry included in the response data acquired through the second process will be referred to as the second search process. In FIG. 7, the processes of steps S708 and S709 correspond to the second search process.

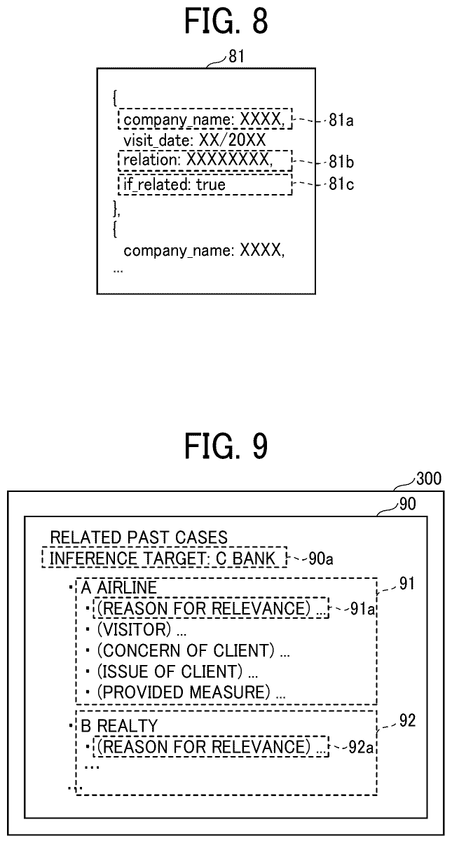

The response data acquired by the response acquisition unit 254 in the second process will be described with reference to FIG. 8. FIG. 8 is a diagram illustrating an example of the response data of the first embodiment.

A description 81 illustrated in FIG. 8 is an example of the response data acquired by the response acquisition unit 254 at step S707 in FIG. 7.

The description 81 includes descriptions 81a, 81b, and 81c. The description 81a indicates, for example, an organization name in a different industry different from but highly related to the industry or work as the issue inference target (the search key). In other words, the description 81a is data identifying the processed data 233 highly related to the search key.

The description 81b indicates text describing how the issue of the industry or work as the issue inference target is related to the issue of the different industry indicated by the description 81a. In other words, the description 81b is data indicating the result of inferring the relation between the issue of the industry or work as the issue inference target and the issue of the industry indicated by the processed data 233 identified in the description 81a. The description 81c indicates the result of determining whether the industry or work as the issue inference target is related to the processed data 233 identified in the description 81a.

A display example of the terminal apparatus 300 of the first embodiment will be described with reference to FIG. 9. FIG. 9 is a diagram illustrating a display example of the terminal apparatus 300 of the first embodiment.

A screen 90 illustrated in FIG. 9 is an example of a screen displayed on the terminal apparatus 300 at step S712 in FIG. 7.

The screen 90 displays the organization data 232 of different industries that are different from the industry indicated by the search key but share the generically conceptualized issue with the industry indicated by the search key and are inferred to be highly related to the industry indicated by the search key. The screen 90 further displays data indicating the result of inferring the relations between the issue of the industry indicated by the search key and the issues of the different industries inferred to be highly related to the industry indicated by the search key.

The screen 90 includes display areas 90a, 91, and 92. The display area 90a displays an organization name “C BANK” indicated by the input data. The display area 91 displays the organization data 232 corresponding to an organization name “A AIRLINE.” The display area 91 includes a display area 91a, which displays data indicating the result of inferring the relation between the issue corresponding to the organization name “C BANK” and the issue corresponding to the organization name “A AIRLINE.”

The display area 92 displays the organization data 232 corresponding to an organization name “B REALTY” and data indicating the result of inferring the relation. The display area 92 includes a display area 92a, which displays data indicating the result of inferring the relation between the issue corresponding to the organization name “C BANK” and the issue corresponding to the organization name “B REALTY.” In the example of FIG. 9, descriptions of reasons for relevance to the two organizations are displayed as the data indicating the result of inferring the relation.

According to the first embodiment, the terminal apparatus 300 thus displays the organization data 232 of an organization in a different industry different in background from the industry input by the user of the terminal apparatus 300 but sharing the generically conceptualized issue with the input industry. The terminal apparatus 300 further displays the description of the reason for relevance of the issue of the industry input by the user to the issue of the organization corresponding to the organization data 232. Accordingly, the first embodiment helps the user of the terminal apparatus 300 recognize the relation between the issue of the organization as the issue inference target and the issue of the organization in the different industry, encouraging the user to examine or review the issue of the organization as the issue inference target from a new perspective.

A second embodiment of the present disclosure will be described with drawings.

The second embodiment is different from the first embodiment in using the LLM 411 to generate the search key for the first search process. The following description of the second embodiment will focus on differences from the first embodiment. Components of the second embodiment similar in function to those of the first embodiment will be denoted with the same reference signs used in the description of the first embodiment, and the description thereof will be omitted.

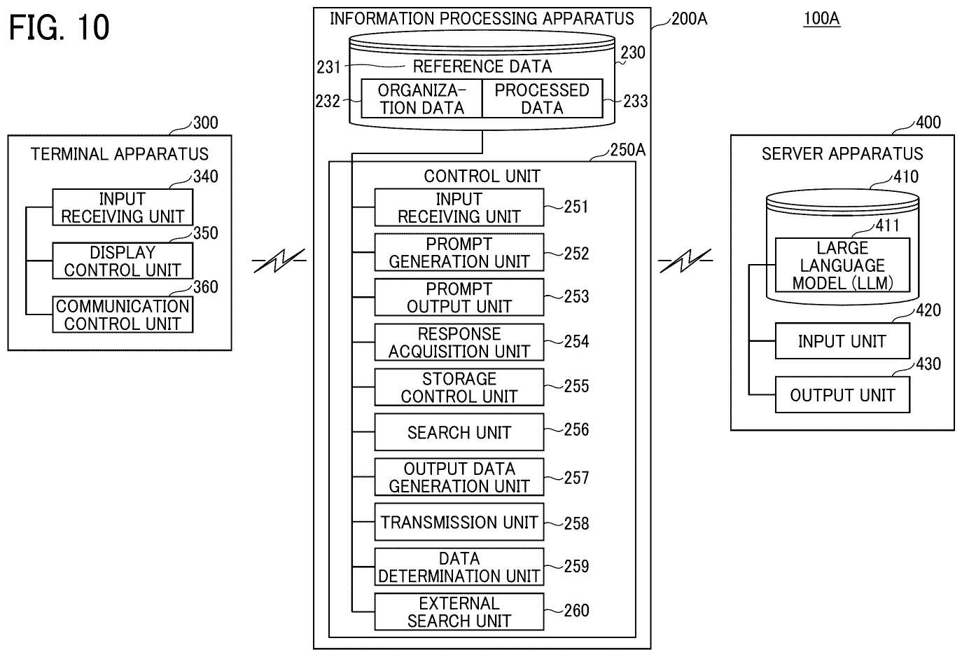

FIG. 10 is a diagram illustrating functional configurations of apparatuses included in an information processing system 100A of the second embodiment.

The information processing system 100A includes an information processing apparatus 200A, which includes the reference data storage unit 230 and a control unit 250A.

The control unit 250A includes a data determination unit 259 and an external search unit 260 in addition to the units included in the control unit 250 of the first embodiment.

The data determination unit 259 determines whether the input data input from the terminal apparatus 300 is file data. File data is, for example, a document field file created in an organization.

The external search unit 260 generates a search request based on the input data, transmits the search request to an external server provided outside the information processing system 100A, and acquires a search result. The external server is, for example, a server residing on the Internet to provide a search service. The external server may be a server included in the information processing system 100A.

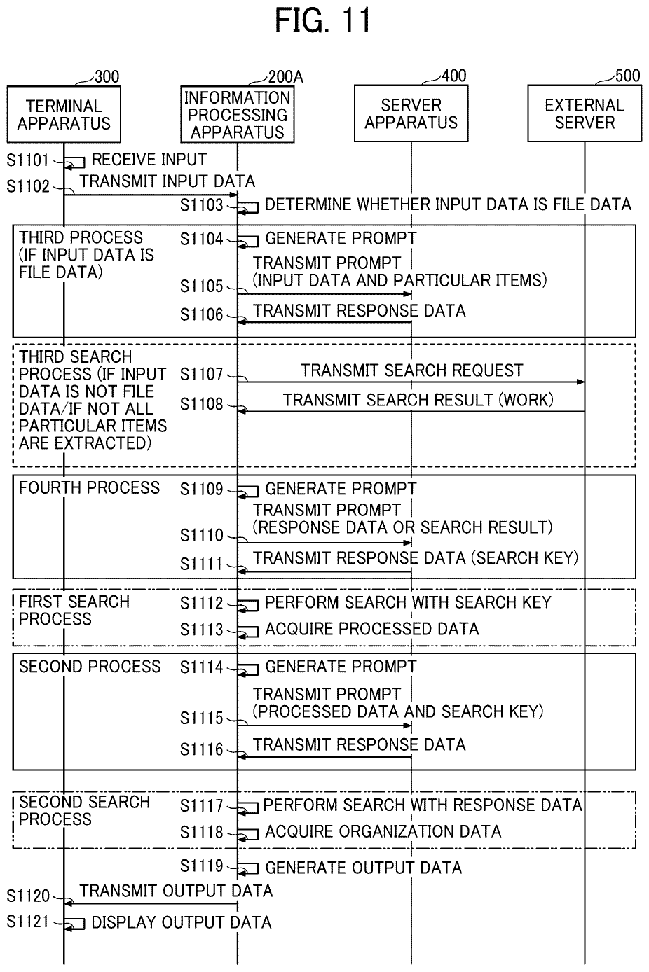

An operation of the information processing system 100A of the second embodiment will be described with reference to FIG. 11. FIG. 11 is a sequence diagram illustrating an operation of the information processing system 100A of the second embodiment.

In the information processing system 100A, the input receiving unit 340 of the terminal apparatus 300 receives the input of input data indicating the industry as the issue inference target (step S1101), and the communication control unit 360 of the terminal apparatus 300 transmits the input data to the information processing apparatus 200A (step S1102).

In the information processing apparatus 200A, the input receiving unit 251 receives the input data, and the data determination unit 259 determines whether the input data is file data (step S1103). If it is determined at step S1103 that the input data is not file data, the information processing apparatus 200A proceeds to step S1107, which will be described later.

If it is determined at step S1103 that the input data is file data, the prompt generation unit 252 of the information processing apparatus 200A generates a prompt requesting to extract the data of particular items from the file data (step S1104).

The prompt generated in this step includes the file data as the input data and data specifying the particular items. The prompt requests to extract the values of the particular items from the input data. The particular items are previously specified by, for example, an administrator of the information processing apparatus 200A. The particular items include work, business strategy, development history, service, and summary of file data, for example.

The prompt output unit 253 of the information processing apparatus 200A then outputs the generated prompt to the server apparatus 400 (step S1105), and the response acquisition unit 254 of the information processing apparatus 200A acquires response data to the prompt from the server apparatus 400 (step S1106). Details of the response data acquired at step S1106 will be described later.

If it is determined at step S1103 that the input data is not file data, or if the response data acquired at step S1106 does not include the values of all particular items, the external search unit 260 of the information processing apparatus 200A transmits a search request to an external server 500 (step S1107).

The search request transmitted to the external server 500 in this step includes the input data or any of the particular items whose value has not been extracted. The search request is for requesting to search for the work corresponding to the input data or the item whose value has not been extracted.

The external search unit 260 of the information processing apparatus 200A then acquires a search result from the external server 500 (step S1108).

The search result acquired in this step includes data indicating the work corresponding to the input data or any of the particular items whose value has not been extracted. The search result acquired in this step may be other data than the data indicating the work, as long as the other data is related to the industry as the issue inference target indicated by the input data.

Alternatively, the external search unit 260 may obtain information via a web search application programming interface (API) and acquire a result of screening the obtained information with, for example, the LLM 411 of the server apparatus 400 as the search result, or may acquire a result obtained from an external generative AI service with a DeepResearch function as the search result. Details of the search result acquired at step S1108 will be described later.

The prompt generation unit 252 of the information processing apparatus 200A then generates a prompt based on the search result acquired by the external search unit 260 at step S1108 (step S1109).

The prompt generated in this step includes at least one of the response data acquired at step S1106 or the search result acquired at step S1108. The prompt is for requesting to generate the search key for use in the search through the reference data storage unit 230 by the search unit 256.

The prompt output unit 253 of the information processing apparatus 200A then outputs the prompt generated at step S1109 to the server apparatus 400 (step S1110).

Then, the response acquisition unit 254 of the information processing apparatus 200A acquires the search key generated by the LLM 411 of the server apparatus 400 as response data (step S1111). The response data acquired in this step includes at least a list of industries. In addition to the list of industries, the response data acquired in this step further includes respective works of the industries. Details of the response data acquired at step S1111 will be described later.

The search unit 256 of the information processing apparatus 200A then searches the processed data 233 stored in the reference data storage unit 230 with the response data acquired at step S1111 as the search key (step S1112).

The processes of steps S1112 to S1121 in FIG. 11 are similar to those of steps S703 to S712 in FIG. 7, and thus the description thereof will be omitted.

The process in FIG. 11 to output the prompt requesting to extract the data of the particular items from the file data and acquire the response data to the prompt will be referred to as the third process. In FIG. 11, the processes of steps S1104 to S1106 correspond to the third process.

The process in FIG. 11 to include the input data or the response data acquired through the third process in the search request and acquire the search result from the external server 500 will be referred to as the third search process. In FIG. 11, the processes of steps S1107 and S1108 correspond to the third search process.

The process in FIG. 11 to output the prompt requesting to generate the search key based on the search result of the third search process and acquire the response data including the search key will be referred to as the fourth process. In FIG. 11, the processes of steps S1109 to S1111 correspond to the fourth process.

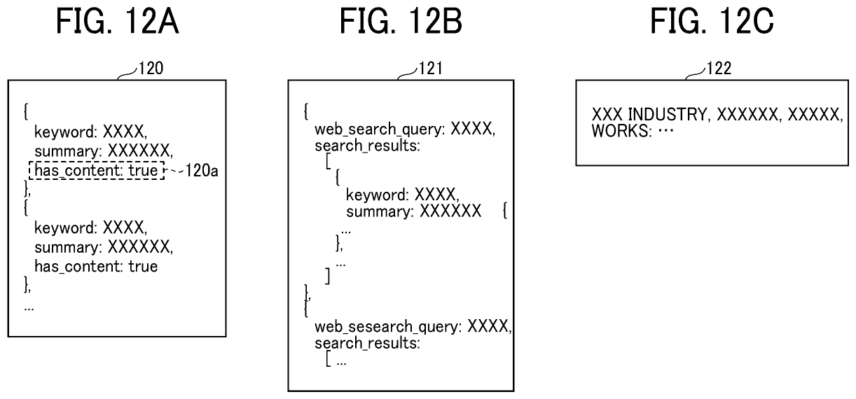

The response data acquired by the response acquisition unit 254 at step S1106 will be described with reference to FIG. 12A. FIGS. 12A, 12B, and 12C are diagrams illustrating results of processing by some of the units of the information processing apparatus 200A of the second embodiment.

A description 120 illustrated in FIG. 12A is an example of the response data that the information processing apparatus 200A acquires from the server apparatus 400 at step S1106 in FIG. 11.

Based on a description 120a included in the description 120, the information processing apparatus 200A determines whether the data of the specified items has been acquired. If the data of any of the specified items has not been acquired, the third search process by the external search unit 260 takes place.

A description 121 illustrated in FIG. 12B is an example of the search result acquired at step S1108 in FIG. 11. For example, the data of an item not acquired in the response data illustrated in FIG. 12A is acquired from the search result indicated by the description 121.

A description 122 illustrated in FIG. 12C is an example of the response data acquired at step S1111 in FIG. 11. The response data indicated by the description 122 includes a search key generated from the response data illustrated in FIG. 12A or the search result illustrated in FIG. 12B. The example of FIG. 12C indicates that a list of multiple industries and works are acquired as the search key.

According to the second embodiment, the LLM 411 is thus caused to generate the search key for the search through the reference data storage unit 230 based on the search result acquired through the search by the external server 500. The second embodiment therefore obviates the need for the user of the terminal apparatus 300 to think of the search key for obtaining the issue inference result. Consequently, the user is able to search the reference data storage unit 230 with an appropriate search key by inputting already generated file data, for example.

In the second embodiment, the external search unit 260 transmits the search request to the single external server 500. However, the configuration is not limited thereto. The external server 500 may include a plurality of servers.

A third embodiment of the present disclosure will be described with reference to drawings.

The third embodiment is different from the second embodiment in proposing a solution for the issue based on owned technique information. The following description of the third embodiment will focus on differences from the second embodiment. Components of the third embodiment similar in function to those of the second embodiment will be denoted with the same reference signs used in the description of the second embodiment, and the description thereof will be omitted.

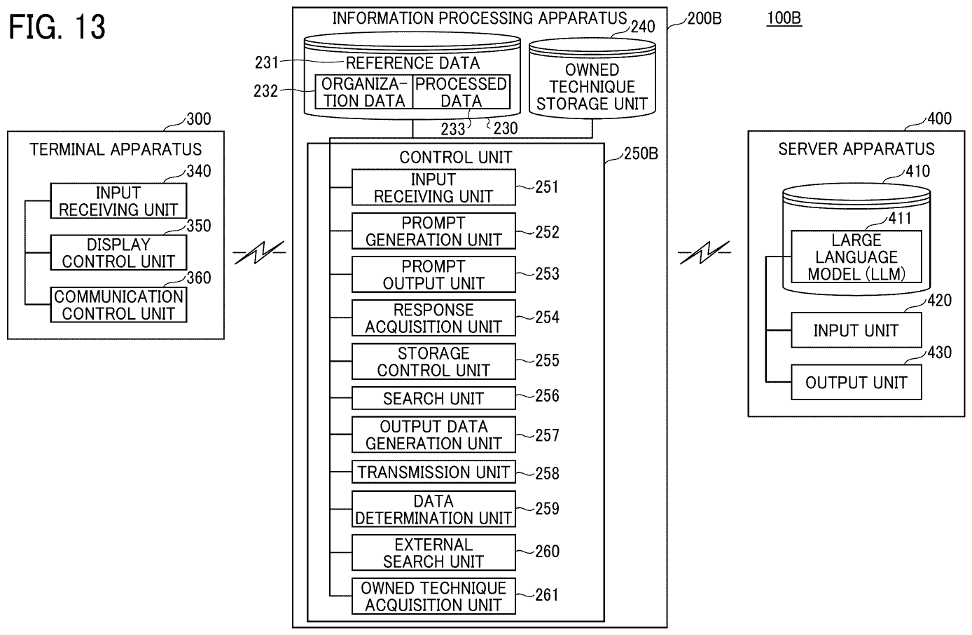

FIG. 13 is a diagram illustrating functional configurations of apparatuses included in an information processing system 100B of the third embodiment.

The information processing system 100B includes an information processing apparatus 200B, which includes the reference data storage unit 230, an owned technique storage unit 240, and a control unit 250B.

The owned technique storage unit 240 stores owned technique information. The owned technique information is information related to a technique owned by a particular organization. The particular organization is, for example, a business operator that provides the information processing system 100B. The owned technique information is previously stored in the owned technique storage unit 240 by, for example, the provider of the information processing system 100B. The owned technique information, however, may not be previously stored in the owned technique storage unit 240, and may be input by, for example, the user of the terminal apparatus 300 together with the input data.

The control unit 250B includes an owned technique acquisition unit 261 in addition to the units included in the control unit 250A of the second embodiment. The owned technique acquisition unit 261 acquires the owned technique information stored in the owned technique storage unit 240.

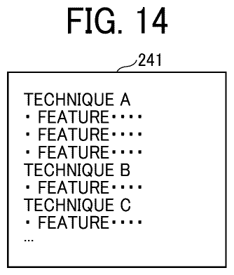

The owned technique information will be described with reference to FIG. 14. FIG. 14 is a diagram illustrating an example of the owned technique information stored in the owned technique storage unit 240.

Owned technique information 241 illustrated in FIG. 14 includes, for example, the types and features of techniques owned by the business operator that provides the information processing system 100B. The third embodiment uses the owned technique information 241 to present the user of the terminal apparatus 300 with a measure to address the inferred issue.

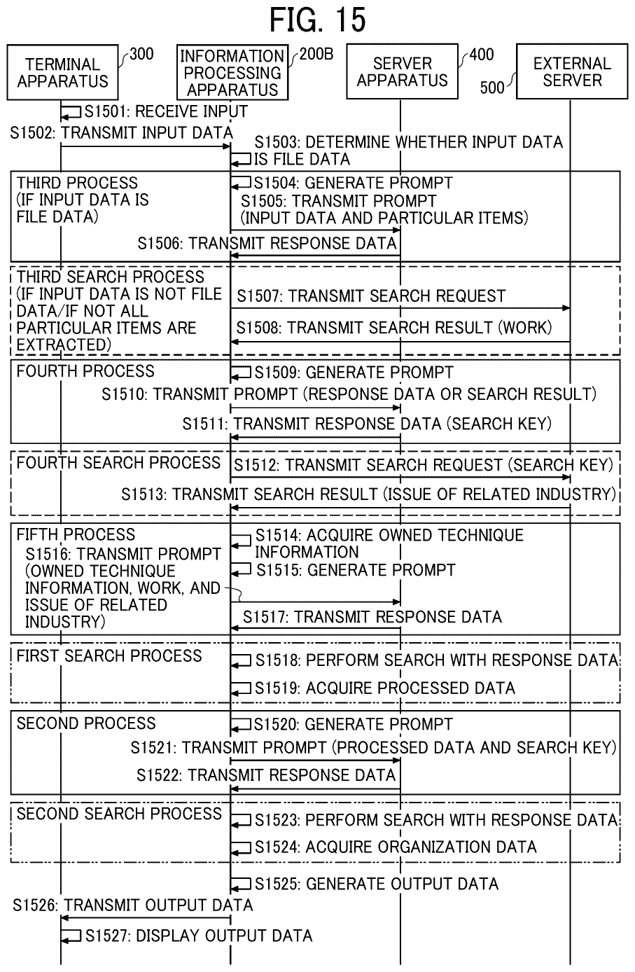

An operation of the information processing system 100B of the third embodiment will be described with reference to FIG. 15. FIG. 15 is a sequence diagram illustrating an operation of the information processing system 100B of the third embodiment.

The processes of steps S1501 to S1511 in FIG. 15 are similar to those of steps S1101 to S1111 in FIG. 11, and thus the description thereof will be omitted.

After the response data is acquired at step S1511 as the processing result of the fourth process, the external search unit 260 of the information processing apparatus 200B transmits to the external server 500 a search request including the response data as a search key (step S1512).

It is assumed here that the response data acquired at step S1511 does not include a work.

The search key included in the search request transmitted to the external server 500 in this step is, for example, the list of industries included in the description 122 in FIG. 12C. The search request transmitted to the external server 500 in this step is for requesting to, with the list of industries of organizations as a search key, search for an issue of a different industry sharing an issue generically conceptualized from an issue of the industries.

The external search unit 260 of the information processing apparatus 200B acquires a search result from the external server 500 (step S1513).

The search result acquired in this step is data indicating an issue related to the issue generically conceptualized from the issue of the industries or works indicated by the search key. In other words, the search result acquired in this step is data indicating the issue of the different industry sharing the issue generically conceptualized from the issue of the industry indicated by the input data.

Alternatively, the external search unit 260 may obtain information via a web search API and acquire a result of screening the obtained information with, for example, the LLM 411 of the server apparatus 400 as the search result, or may acquire a result obtained from an external generative AI service with a DeepResearch function as the search result. Details of the search result acquired at step S1513 will be described later.

In the information processing apparatus 200B, the owned technique acquisition unit 261 acquires the owned technique information stored in the owned technique storage unit 240 (step S1514), and the prompt generation unit 252 generates a prompt (step S1515).

The prompt generated in this step includes the owned technique information acquired at step S1514 and the search results acquired at steps S1508 and S1513.

Specifically, the prompt generated in this step includes the owned technique information, data indicating the work corresponding to the industry indicated by the input data, and the data indicating the issue of the different industry sharing the issue generically conceptualized from the issue of the industry indicated by the input data. The prompt is for requesting to infer an issue related to the owned technique information and applicable to the industry indicated by the input data.

The prompt generated in this step further includes text data requesting to infer a measure using the owned technique information to address the issue related to the owned technique information and applicable to the industry indicated by the input data.

Then, the prompt output unit 253 of the information processing apparatus 200B outputs the generated prompt to the server apparatus 400 (step S1516), and the response acquisition unit 254 of the information processing apparatus 200B acquires response data from the server apparatus 400 (step S1517).

The response data acquired in this step includes an inference result indicating the inferred issue related to the owned technique information and applicable to the industry indicated by the input data and the inferred measure using the owned technique information to address the issue.

The search unit 256 of the information processing apparatus 200B then searches the processed data 233 in the reference data storage unit 230 with the response data acquired at step S1517 as the search key (step S1518).

The processes of steps S1518 to S1527 in FIG. 15 are similar to those of steps S1112 to S1121 in FIG. 11 except for including the response data acquired at step S1517 in the output data at step S1525, and thus the description thereof will be omitted.

The process in FIG. 15 to include the response data acquired through the fourth process in the search request and acquire the search result from the external server 500 will be referred to as the fourth search process. In FIG. 15, the processes of steps S1512 and S1513 correspond to the fourth search process.

The process in FIG. 15 to acquire the owned technique information, output the prompt including the owned technique information, the search result acquired through the third search process, and the search result acquired through the fourth search process, and acquire the response data including the inference result indicating the inferred issue related to the owned technique information and applicable to the industry indicated by the input data and the inferred measure using the owned technique information to address the issue will be referred to as the fifth process. In FIG. 15, the processes of steps S1514 to S1517 correspond to the fifth process.

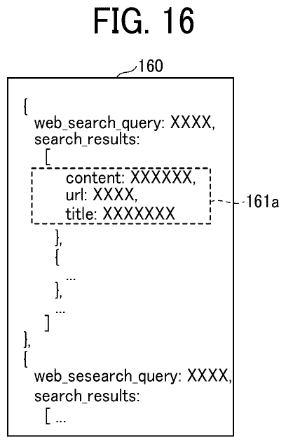

The search result acquired at step S1513 will be described with reference to FIG. 16. FIG. 16 is a diagram illustrating an example of the search result of the third embodiment.

A description 160 illustrated in FIG. 16 is an example of the search result acquired at step S1513 in FIG. 15.

In the example of FIG. 16, the data included in a uniform resource locator (URL) indicated by a description 161a is the data acquired as the search result. The data acquired as the search result is the data indicating the issue of the different industry sharing the issue generically conceptualized from the issue of the industry indicated by the input data.

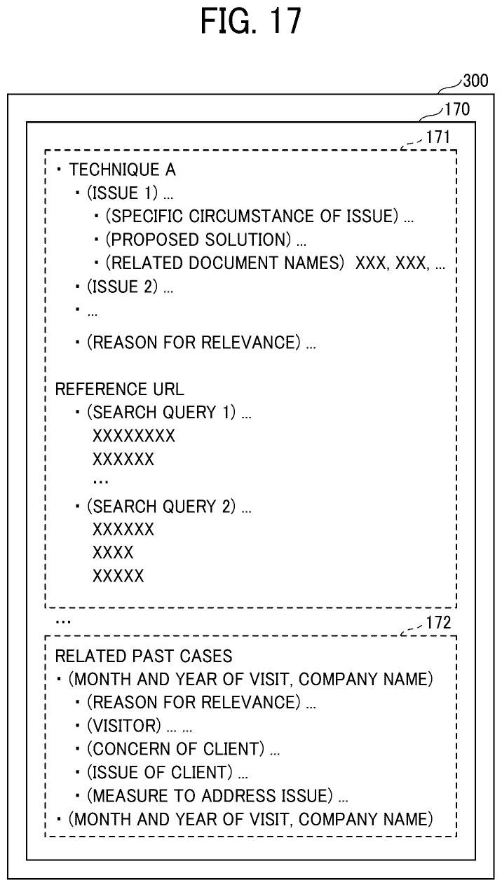

A display example of the terminal apparatus 300 of the third embodiment will be described with reference to FIG. 17. FIG. 17 is a diagram illustrating a display example of the terminal apparatus 300 of the third embodiment.

A screen 170 illustrated in FIG. 17 is an example of a screen displayed on the terminal apparatus 300 at step S1527 in FIG. 15.

The screen 170 includes display areas 171 and a 172. The display area 171 displays the response data acquired at step S1517 in FIG. 15. The display area 172 displays the output data generated at step S1525 in FIG. 15.

Specifically, the display area 171 displays data including each issue related to an owned technique A and a proposed solution for the issue as the inference result indicating the inferred issue related to the owned technique information and applicable to the industry indicated by the input data and the inferred measure using the owned technique information to address the issue.

The display area 172 displays the organization data 232 associated with the processed data 233 obtained from searching the reference data storage unit 230 with the response data displayed in the display area 171 as the search key.

More specifically, the information processing apparatus 200B searches the processed data 233 in the reference data storage unit 230 with the response data acquired at step S1517, and acquires, as the search result, the processed data 233 including the issue related to the owned technique A and the proposed solution for the issue. The information processing apparatus 200B then acquires, from the reference data storage unit 230, the organization data 232 associated with the processed data 233 as the search result, and generates output data including the acquired organization data 232.

That is, the display area 172 displays, out of all organization data 232 stored in the reference data storage unit 230, the organization data 232 including the issue related to the owned technique A and the proposed solution for the issue.

According to the third embodiment, in response to the issue related to the industry indicated by the input data, the terminal apparatus 300 thus displays the organization data 232 including cases whose issues have been solved with the owned techniques indicated by the owned technique information. In other words, according to the third embodiment, in addressing the issue of the industry inferred based on the input data, the user of the terminal apparatus 300 is able to know proposals made in the past as solutions using the owned techniques owned by the provider of the information processing system 100B.

A fourth embodiment of the present disclosure will be described with reference to drawings. The fourth embodiment is different from the third embodiment in the order of executing the fifth process. The following description of the fourth embodiment will focus on differences from the third embodiment. Components of the fourth embodiment similar in function to those of the third embodiment will be denoted with the same reference signs used in the description of the third embodiment, and the description thereof will be omitted.

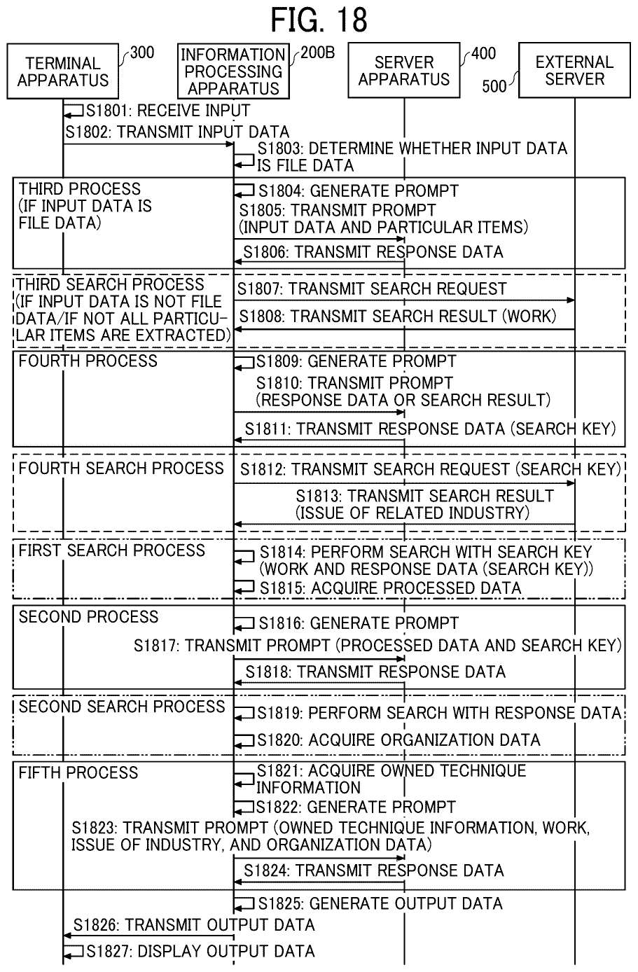

FIG. 18 is a sequence diagram illustrating an operation of the information processing system 100B of the fourth embodiment.

The processes of steps S1801 to S1813 in FIG. 18 are similar to those of steps S1501 to S1513 in FIG. 15, and thus the description thereof will be omitted.

After the search result of the fourth search process is acquired at step S1813, the search unit 256 of the information processing apparatus 200B searches the processed data 233 in the reference data storage unit 230 by using the search result acquired through the third search process and the response data acquired through the fourth process as the search key (step S1814).

The search result acquired through the third search process includes the data indicating the work of the industry indicated by the input data. The response data acquired through the fourth process is the search key for use in the search through the reference data storage unit 230. The search key is generated based on the response data acquired at step S1806 or the search result acquired at step S1808.

The processes of steps S1815 to S1820 in FIG. 18 are similar to those of steps S1519 to S1524 in FIG. 15, and thus the description thereof will be omitted.

After the organization data 232 is acquired at step S1820, the owned technique acquisition unit 261 of the information processing apparatus 200B acquires the owned technique information stored in the owned technique storage unit 240 (step S1821).

The prompt generation unit 252 of the information processing apparatus 200B then generates a prompt including the acquired owned technique information (step S1822).

The prompt generated in this step includes the owned technique information acquired at step S1821, the search results acquired at steps S1808 and S1813, and the organization data 232 acquired at step S1820.

Specifically, the prompt generated in this step includes the owned technique information, the data indicating the work corresponding to the industry indicated by the input data, the data indicating the issue of the different industry sharing the issue generically conceptualized from the issue of the industry indicated by the input data, and the organization data 232 of the industry related to the industry indicated by the input data. The prompt is for requesting to infer the issue related to the owned technique information and applicable to the industry indicated by the input data.

The prompt generated in this step further includes text data requesting to infer the measure using the owned technique information to address an issue of the industry related to the industry indicated by the input data.

The prompt output unit 253 of the information processing apparatus 200B then outputs the prompt generated at step S1822 to the server apparatus 400 (step S1823).

Then, the response acquisition unit 254 of the information processing apparatus 200B acquires response data from the server apparatus 400 (step S1824). The response data acquired in this step includes the inference result indicating the inferred issue related to the owned technique information and applicable to the industry indicated by the input data and the inferred measure using the owned technique information to address the issue.

The processes of steps S1825 to S1827 in FIG. 18 are similar to those of steps S1525 to S1527 in FIG. 15, and thus the description thereof will be omitted.

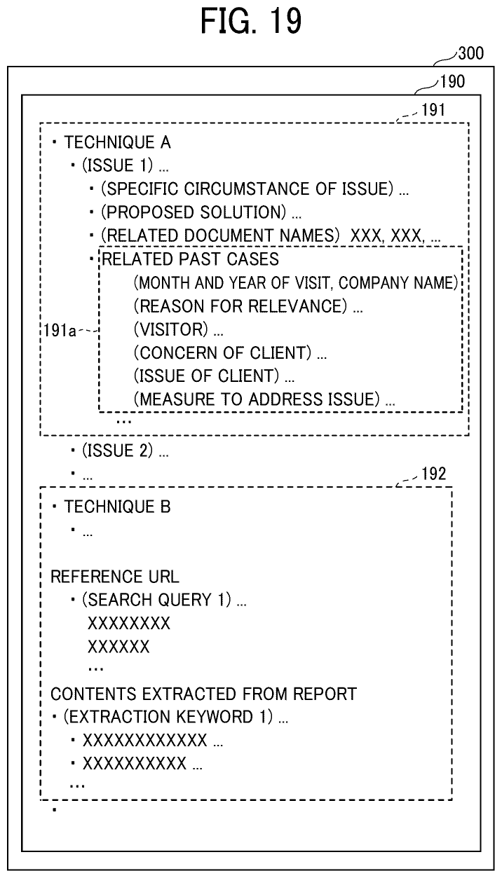

A display example of the terminal apparatus 300 of the fourth embodiment will be described with reference to FIG. 19. FIG. 19 is a diagram illustrating a display example of the terminal apparatus 300 of the fourth embodiment.

A screen 190 illustrated in FIG. 19 is an example of a screen displayed on the terminal apparatus 300 at step S1827 in FIG. 18.

The screen 190 includes display areas 191 and 192. The display area 191 displays data including an issue related to the owned technique A and a proposed solution for the issue as the inference result indicating the inferred issue related to the owned technique information and the inferred measure using the owned technique information to address the issue. The display area 192 displays data including an issue related to an owned technique B and a proposed solution for the issue as the inference result indicating the inferred issue related to the owned technique information and the inferred measure using the owned technique information to address the issue.

In the fourth embodiment, the organization data 232 acquired at step S1820 in FIG. 18 is displayed as part of the inference result displayed in the display area 191. In the example of FIG. 19, the display area 191 includes a display area 191a. The display area 191a displays the organization data 232 acquired from the reference data storage unit 230 at step S1820 in FIG. 18.

According to the fourth embodiment, the organization data 232 stored in the reference data storage unit 230 is thus displayed on the terminal apparatus 300 as part of cases whose issues have been solved with the owned techniques indicated by the owned technique information.

A fifth embodiment of the present disclosure will be described with reference to drawings. The fifth embodiment is different from the third embodiment in not including the reference data storage unit 230. The following description of the fifth embodiment will focus on differences from the third embodiment. Components of the fifth embodiment similar in function to those of the third embodiment will be denoted with the same reference signs used in the description of the third embodiment, and the description thereof will be omitted.

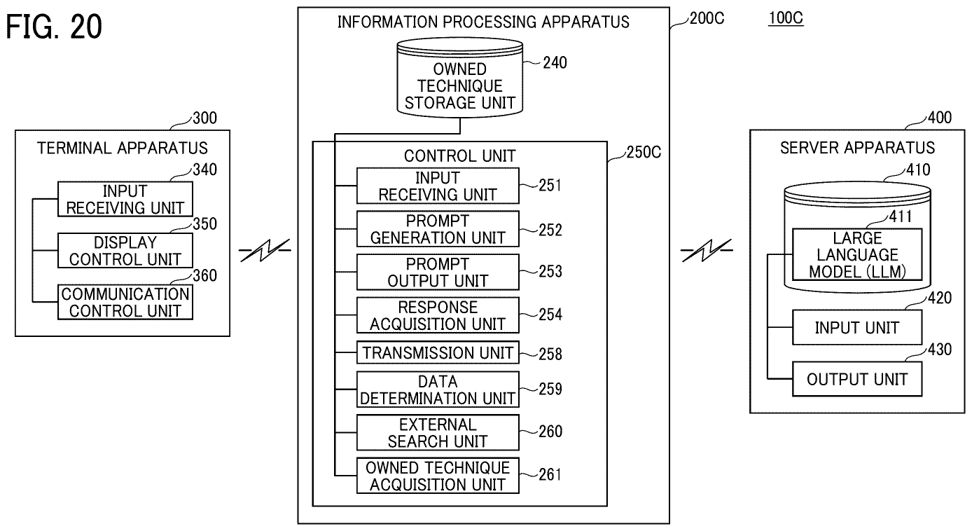

FIG. 20 is a diagram illustrating functional configurations of apparatuses included in an information processing system 100C of the fifth embodiment.

The information processing system 100C includes an information processing apparatus 200C, which includes the owned technique storage unit 240 and a control unit 250C.

The control unit 250C includes the input receiving unit 251, the prompt generation unit 252, the prompt output unit 253, the response acquisition unit 254, the transmission unit 258, the data determination unit 259, the external search unit 260, and the owned technique acquisition unit 261.

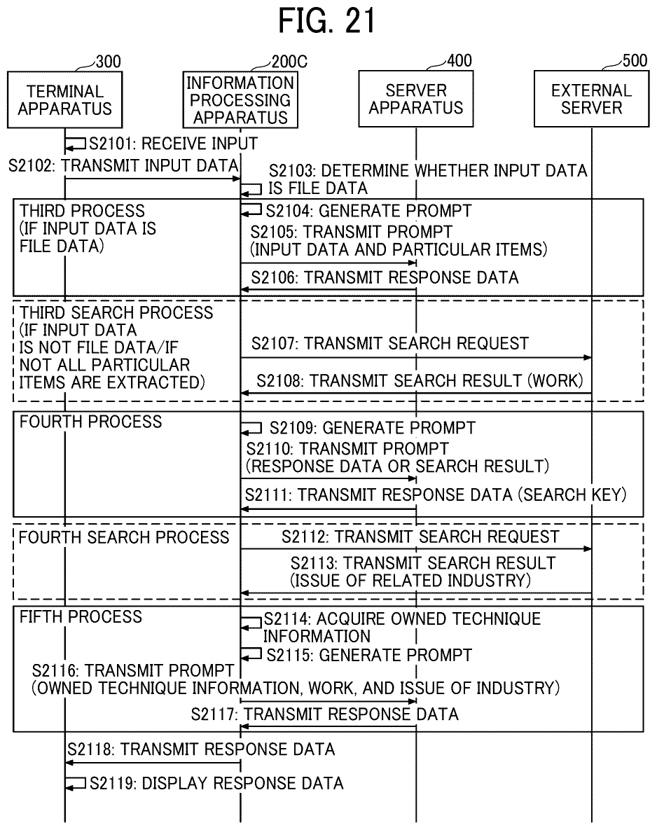

FIG. 21 is a sequence diagram illustrating an operation of the information processing system 100C of the fifth embodiment.

The processes of steps S2101 to S2117 in FIG. 21 are similar to those of steps S1501 to S1517 in FIG. 15, and thus the description thereof will be omitted.

After the response data is acquired by the response acquisition unit 254 at step S2117, the transmission unit 258 of the information processing apparatus 200C transmits the acquired response data to the terminal apparatus 300 (step S2118).

In the terminal apparatus 300, the communication control unit 360 receives the response data, and the display control unit 350 causes the display 318 to display the received response data (step S2119).

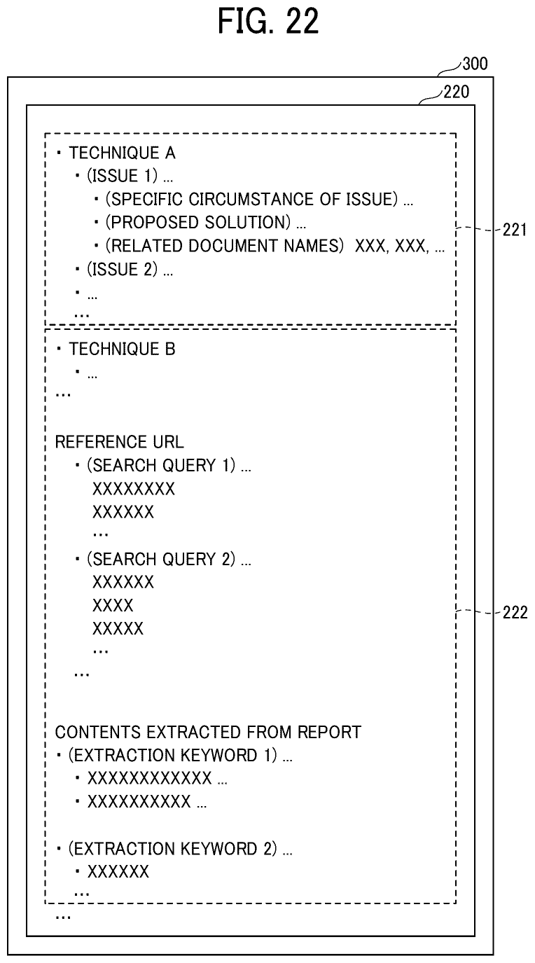

A display example of the terminal apparatus 300 of the fifth embodiment will be described with reference to FIG. 22. FIG. 22 is a diagram illustrating a display example of the terminal apparatus 300 of the fifth embodiment.

A screen 220 illustrated in FIG. 22 is an example of a screen displayed on the terminal apparatus 300 at step S2119 in FIG. 21.

The screen 220 includes display areas 221 and 222, which display the response data acquired at step S2117 in FIG. 21. Specifically, the display area 221 displays data including each issue related to the owned technique A and a proposed solution for the issue as the inference result indicating the inferred issue related to the owned technique information and applicable to the industry indicated by the input data and the inferred measure using the owned technique information to address the issue. The display area 222 displays data including each issue related to the owned technique B and a proposed solution for the issue.

According to the fifth embodiment, the issue of the industry related to the industry and indicated by the input data is thus inferred based on the input data, and the measure using the owned technique information to address the inferred issue of the industry is inferred. The fifth embodiment therefore presents the user of the terminal apparatus 300 with the measure employed by a company or organization owning an existing technique to address the issue.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses described in the embodiments are only illustrative of one of several computing environments for implementing the embodiments disclosed herein.

In some embodiments, the information processing apparatus 200 includes a plurality of computing devices, e.g., a server cluster, that are configured to communicate with each other over any type of communications link, including a network, a shared memory, etc. to collectively perform the processes disclosed herein. Similarly, the information processing apparatus 200 can include a plurality of computing devices that are configured to communicate with each other.

Moreover, the information processing apparatus 200 can be configured to share the disclosed processing steps in various combinations. For example, the processes performed by a particular unit can be performed by the information processing apparatus 200. Similarly, the functionality of a particular unit can be performed by the information processing apparatus 200. Further, the components of the information processing apparatus 200 may be included in a single server apparatus or distributed to a plurality of apparatuses.

The information processing apparatus 200 may be any apparatus with a communication function. The information processing apparatus 200 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

The present disclosure has the following aspects, for example.

According to a first aspect, an information processing apparatus includes an input receiving unit, a prompt output unit, and a transmission unit. The input receiving unit receives an input of input data. The prompt output unit outputs a prompt to a large language model. The transmission unit transmits output data to a terminal apparatus. The output data includes an inference result from the large language model. The prompt output unit outputs to the large language model a prompt requesting to infer, using reference data, a relation between an issue of an industry indicated by the input data and an issue of a different industry. The reference data is stored in a reference data storage unit for each organization of a plurality of organizations in different industries. The reference data associates organization data related to the organization with processed data including a generically conceptualized issue generalized from an issue of the organization. The different industry shares the generically conceptualized issue with the industry indicated by the input data. The transmission unit transmits to the terminal apparatus output data that includes data indicating the relation between the issue of the industry indicated by the input data and the issue of the different industry sharing the generically conceptualized issue with the industry indicated by the input data.

According to a second aspect, the information processing apparatus of the first aspect further includes a search unit and a response acquisition unit. The search unit searches the reference data storage unit. The response acquisition unit acquires response data including an inference result from the large language model according to a prompt. The search unit searches the reference data storage unit with the input data as a search key, and acquires processed data as a search result. The prompt requests to infer a relation between the input data and the processed data acquired as the search result, and identify processed data that is included in the processed data acquired as the search result and is highly related to the input data. The response data includes data identifying the processed data highly related to the input data. The response data further includes data indicating a result of inferring a relation between the input data and the identified processed data. The output data includes the data indicating the result of inferring the relation between the input data and the identified processed data and organization data associated with the identified processed data in the reference data storage unit.

According to a third aspect, in the information processing apparatus of the first or second aspect, the input data includes at least one of an industry, a work, or an organization name as an issue inference target.

According to a fourth aspect, the information processing apparatus of the second or third aspect further includes an external search unit that transmits a search request to an external server to search for a work corresponding to the input data, and acquires a search result including data indicating the work corresponding to the input data. The prompt output unit outputs to the large language model a prompt requesting to generate a search key based on the data indicating the work corresponding to the input data. The response acquisition unit acquires response data to the prompt from the large language model. The response data includes a list of industries of organizations. The search unit searches the reference data storage unit with the list of industries of organizations as the search key to acquire the processed data as the search result.

According to a fifth aspect, the information processing apparatus of the fourth aspect further includes a data determination unit that determines whether the input data is file data. Based on a determination that the input data is the file data, the prompt output unit outputs to the large language model a prompt requesting to extract respective values of a plurality of particular items from the input data. Based on a determination that the value of an item of the plurality of particular items is yet to be extracted, the external search unit transmits a search request to the external server to search for a work corresponding to the item.

According to a sixth aspect, the information processing apparatus of the fourth aspect further includes an owned technique acquisition unit that acquires owned technique information related to a technique owned by a particular organization. The external search unit transmits a search request to the external server to, with the list of industries of organizations as a search key, search for an issue of a different industry different from the industries and sharing a generically conceptualized issue generalized from an issue of the industries. The external search unit acquires data indicating the issue of the different industry as a search result. The prompt output unit outputs a prompt to the large language model. The prompt includes the owned technique information, the data indicating the work corresponding to the input data, and the data indicating the issue of the different industry. The prompt requests to infer an issue related to the owned technique information and applicable to the industry indicated by the input data, and infer a measure using the owned technique information to address the issue related to the owned technique information and applicable to the industry indicated by the input data. The response acquisition unit acquires response data output from the large language model in accordance with the prompt. The search unit searches the reference data storage unit with the response data acquired by the response acquisition unit as the search key.

According to a seventh aspect, the information processing apparatus of the fourth aspect further includes an owned technique acquisition unit that acquires owned technique information related to a technique owned by a particular organization. The external search unit transmits a search request to the external server to, with the list of industries of organizations as a search key, search for an issue of a different industry different from the industries and sharing a generically conceptualized issue generalized from an issue of the industries. The external search unit acquires data indicating the issue of the different industry as a search result. The prompt output unit outputs a prompt to the large language model. The prompt includes the owned technique information, the data indicating the work corresponding to the input data, the data indicating the issue of the different industry, and the organization data associated with the identified processed data in the reference data storage unit. The prompt requests to infer an issue related to the owned technique information and applicable to the industry indicated by the input data, and infer a measure using the owned technique information to address the issue related to the owned technique information and applicable to the industry indicated by the input data. The response acquisition unit acquires response data output from the large language model in accordance with the prompt. The transmission unit transmits, to the terminal apparatus, output data that includes an inference result indicated by the response data acquired by the response acquisition unit and the organization data associated with the identified processed data in the reference data storage unit.

According to an eighth aspect, an information processing apparatus includes an input receiving unit, an external search unit, an owned technique acquisition unit, a prompt output unit, and a transmission unit. The input receiving unit receives an input of input data. The external search unit transmits a search request to an external server to acquire a search result. The owned technique acquisition unit acquires owned technique information related to a technique owned by a particular organization. The prompt output unit outputs a prompt to a large language model. The transmission unit transmits, to a terminal apparatus, output data including response data from the large language model. The external search unit transmits the search request to the external server to search for a work corresponding to the input data, and acquires the search result, which includes data indicating the work corresponding to the input data. The external search unit further transmits another search request to the external server to, with a list of industries inferred based on the work as a search key, search for an issue of a different industry different from the industries and sharing a generically conceptualized issue generalized from an issue of the industries. The external search unit acquires data indicating the issue of the different industry as the search result. The prompt output unit outputs a prompt to a large language model. The prompt includes the owned technique information, the data indicating the work corresponding to the input data, and data indicating the issue of the different industry. The prompt requests to infer an issue related to the owned technique information and applicable to an industry indicated by the input data, and infer a measure using the owned technique information to address the issue related to the owned technique information and applicable to the industry indicated by the input data. The transmission unit transmits, to the terminal apparatus, output data that includes an inference result from the large language model.

According to a ninth aspect, an information processing method performed by an information processing apparatus includes receiving an input of input data, outputting a prompt to a large language model, and transmitting output data to a terminal apparatus. The output data includes an inference result from the large language model. The outputting includes outputting to the large language model a prompt requesting to infer, using reference data, a relation between an issue of an industry indicated by the input data and an issue of a different industry. The reference data is stored in a reference data storage unit for each organization of a plurality of organizations in different industries. The reference data associates organization data related to the organization with processed data including a generically conceptualized issue generalized from an issue of the organization. The different industry shares the generically conceptualized issue with the industry indicated by the input data. The transmitting includes transmitting to the terminal apparatus output data that includes data indicating the relation between the issue of the industry indicated by the input data and the issue of the different industry sharing the generically conceptualized issue with the industry indicated by the input data.

According to a tenth aspect, a non-transitory recording medium stores a plurality of instructions which, when executed by one or more processors of an information processing apparatus, causes the one or more processors to perform a process of receiving an input of input data, outputting a prompt to a large language model, and transmitting output data to a terminal apparatus. The output data includes an inference result from the large language model. The outputting includes outputting to the large language model a prompt requesting to infer, using reference data, a relation between an issue of an industry indicated by the input data and an issue of a different industry. The reference data is stored in a reference data storage unit for each organization of a plurality of organizations in different industries. The reference data associates organization data related to the organization with processed data including a generically conceptualized issue generalized from an issue of the organization. The different industry shares the generically conceptualized issue with the industry indicated by the input data. The transmitting includes transmitting to the terminal apparatus output data that includes data indicating the relation between the issue of the industry indicated by the input data and the issue of the different industry sharing the generically conceptualized issue with the industry indicated by the input data.

According to an eleventh aspect, an information processing system includes an information processing apparatus and a terminal apparatus that communicates with the information processing apparatus via a network. The information processing apparatus includes an input receiving unit, a prompt output unit, and a transmission unit. The input receiving unit receives an input of input data. The prompt output unit outputs a prompt to a large language model. The transmission unit transmits output data to a terminal apparatus. The output data includes an inference result from the large language model. The terminal apparatus includes a receiving unit and a display control unit. The receiving unit receives the output data. The display control unit causes a display unit to display the received output data. The prompt output unit outputs to the large language model a prompt requesting to infer, using reference data, a relation between an issue of an industry indicated by the input data and an issue of a different industry. The reference data is stored in a reference data storage unit for each organization of a plurality of organizations in different industries. The reference data associates organization data related to the organization with processed data including a generically conceptualized issue generalized from an issue of the organization. The different industry shares the generically conceptualized issue with the industry indicated by the input data. The transmitting unit transmits to the terminal apparatus output data that includes data indicating the relation between the issue of the industry indicated by the input data and the issue of the different industry sharing the generically conceptualized issue with the industry indicated by the input data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising circuitry configured to
receive an input of input data,
output a first prompt to a large language model, the first prompt requesting to infer, using reference data, a relation between an issue of an industry indicated by the input data and an issue of a different industry,
the reference data being stored in a memory for each organization of a plurality of organizations in different industries, and associating organization data related to the organization with processed data including a generically conceptualized issue generalized from an issue of the organization, and
the different industry sharing the generically conceptualized issue with the industry indicated by the input data, and
transmit output data to a terminal apparatus, the output data including an inference result from the large language model and indicating the relation between the issue of the industry indicated by the input data and the issue of the different industry sharing the generically conceptualized issue with the industry indicated by the input data.

2. The information processing apparatus of claim 1, wherein the circuitry
searches the memory with the input data as a search key to acquire processed data as a search result, and
acquires response data from the large language model, the response data indicating an inference result output from the large language model in response to the first prompt,
the first prompt requesting to infer a relation between the input data and the processed data acquired as the search result, and identify processed data that is included in the processed data acquired as the search result and is highly related to the input data,
the response data including
data identifying the processed data highly related to the input data, and
data indicating a result of inferring a relation between the input data and the identified processed data, and
the output data including
the data indicating the result of inferring the relation between the input data and the identified processed data, and
organization data associated with the identified processed data in the memory.

3. The information processing apparatus of claim 1, wherein the input data includes at least one of an industry, a work, or an organization name as an issue inference target.

4. The information processing apparatus of claim 2, wherein the circuitry
transmits a search request to an external server to search for a work corresponding to the input data,
acquires a search result including data indicating the work corresponding to the input data,
outputs to the large language model a second prompt requesting to generate a search key based on the data indicating the work corresponding to the input data,
acquires response data to the second prompt from the large language model, the response data to the second prompt including a list of industries of organizations, and
searches the memory with the list of industries of organizations as the search key to acquire the processed data as the search result.

5. The information processing apparatus of claim 4, wherein the circuitry
determines whether the input data is file data,
based on a determination that the input data is the file data, outputs to the large language model a third prompt requesting to extract respective values of a plurality of particular items from the input data, and
based on a determination that the value of an item of the plurality of particular items is yet to be extracted, transmits a search request to the external server to search for a work corresponding to the item.

6. The information processing apparatus of claim 4, wherein the circuitry
acquires owned technique information related to a technique owned by a particular organization,
transmits a search request to the external server to, with the list of industries of organizations as a search key, search for an issue of a different industry different from the industries and sharing a generically conceptualized issue generalized from an issue of the industries,
acquires data indicating the issue of the different industry as a search result,
outputs a third prompt to the large language model,
the third prompt including the owned technique information, the data indicating the work corresponding to the input data, and the data indicating the issue of the different industry, and
the third prompt requesting to infer an issue related to the owned technique information and applicable to the industry indicated by the input data, and infer a measure using the owned technique information to address the issue related to the owned technique information and applicable to the industry indicated by the input data,
acquires response data output from the large language model in accordance with the third prompt, and
searches the memory with the acquired response data as the search key.

7. The information processing apparatus of claim 4, wherein the circuitry
acquires owned technique information related to a technique owned by a particular organization,
transmits a search request to the external server to, with the list of industries of organizations as a search key, search for an issue of a different industry different from the industries and sharing a generically conceptualized issue generalized from an issue of the industries,
acquires data indicating the issue of the different industry as a search result,
outputs a third prompt to the large language model,
the third prompt including the owned technique information, the data indicating the work corresponding to the input data, the data indicating the issue of the different industry, and the organization data associated with the identified processed data in the memory, and
the third prompt requesting to infer an issue related to the owned technique information and applicable to the industry indicated by the input data, and infer a measure using the owned technique information to address the issue related to the owned technique information and applicable to the industry indicated by the input data,
acquires response data output from the large language model in accordance with the third prompt, and
transmits, to the terminal apparatus, output data including an inference result indicated by the acquired response data and the organization data associated with the identified processed data in the memory.

8. An information processing apparatus comprising circuitry configured to
receive an input of input data,
transmit a search request to an external server to search for a work corresponding to the input data,
acquire a search result including data indicating the work corresponding to the input data,
transmit another search request to the external server to, with a list of industries inferred based on the work as a search key, search for an issue of a different industry different from the industries and sharing a generically conceptualized issue generalized from an issue of the industries,
acquire data indicating the issue of the different industry as another search result,
output a first prompt to a large language model,
the first prompt including owned technique information related to a technique owned by a particular organization, the data indicating the work corresponding to the input data, and the data indicating the issue of the different industry, and
the first prompt requesting to infer an issue related to the owned technique information and applicable to an industry indicated by the input data, and infer a measure using the owned technique information to address the issue related to the owned technique information and applicable to the industry indicated by the input data, and
transmit output data to a terminal apparatus, the output data including an inference result from the large language model.

9. An information processing method comprising:
receiving an input of input data;
outputting a first prompt to a large language model, the first prompt requesting to infer, using reference data, a relation between an issue of an industry indicated by the input data and an issue of a different industry,
the reference data being stored in a memory for each organization of a plurality of organizations in different industries, and associating organization data related to the organization with processed data including a generically conceptualized issue generalized from an issue of the organization, and
the different industry sharing the generically conceptualized issue with the industry indicated by the input data, and
transmitting output data to a terminal apparatus, the output data including an inference result from the large language model and indicating the relation between the issue of the industry indicated by the input data and the issue of the different industry sharing the generically conceptualized issue with the industry indicated by the input data.

10. An information processing system comprising:
an information processing apparatus; and
a terminal apparatus to communicate with the information processing apparatus via a network,
the information processing apparatus including first circuitry configured to
receive an input of input data,
output a first prompt to a large language model, the first prompt requesting to infer, using reference data, a relation between an issue of an industry indicated by the input data and an issue of a different industry,
the reference data being stored in a memory for each organization of a plurality of organizations in different industries, and associating organization data related to the organization with processed data including a generically conceptualized issue generalized from an issue of the organization, and
the different industry sharing the generically conceptualized issue with the industry indicated by the input data, and
transmit output data to a terminal apparatus, the output data including an inference result from the large language model and indicating the relation between the issue of the industry indicated by the input data and the issue of the different industry sharing the generically conceptualized issue with the industry indicated by the input data, and
the terminal apparatus including second circuitry configured to
receive the output data, and
display the received output data on a display.
